(19) United States
(12) Patent Application Publication
(10) Pub. No.: US 2016/0016825 A1
(43) Pub. Date: Jan. 21, 2016

(54) MOBILE, HIGH QUALITY, WATER TREATMENT SYSTEMS, APPARATUS, AND METHODS USABLE IN HARSH ENVIRONMENTS

(71) Applicant: Omni Water Solutions, Inc., Austin, TX (US)

(72) Inventor: William Roberts, Austin, TX (US)

(21) Appl. No.: 14/720,103

(22) Filed: May 22, 2015

Related U.S. Application Data
(60) Provisional application No. 62/002,080, filed on May 22, 2014.

(51) Int. Cl. C02F 1/44; C02F 1/28

(52) U.S. Cl. CPC C02F 1/441; C02F 1/28; C02F 2201/008; C02F 2103/08

(57) ABSTRACT

Water purification systems, apparatus, and methods for producing high quality water in harsh environments. Systems of embodiments comprise trailers and reverse osmosis (RO) units and/or multi-media filters (MMFs), and vibration controls. Some controls can be coupled to the trailer and RO units and/or MMFs. The controls can be configured to isolate these components from vibrations. Some systems further comprise pumps and motor/belt drives operationally coupled to the RO units. Some systems comprise enclosures, heaters, and ventilation fans wherein the enclosures enclose the RO units/MMFs, the heaters heat the same, and the fans ventilate the enclosures. Various systems further comprise controllers and water quality sensors. Some of these controllers transmit the sensed conditions and/or actuate the effectors responsive to the sensed conditions. If desired, some systems comprise recirculation lines from the RO units and/or MMFs. Note that the effectors can further comprise bodies formed from composite materials.

### CROSS REFERENCE TO RELATED APPLICATIONS

This application claims priority to and is a non-provisional application of U.S. provisional patent application No. 62/002,080 titled MOBILE WATER TREATMENT UNITS, SYSTEMS, APPARATUS, AND RELATED METHODS, filed by William Roberts on May 22, 2014 the entirety of which is incorporated herein as if set forth in full.

### BACKGROUND

As field operations and humanitarian relief personnel operate in remote areas, access to safe, clean potable water is becoming increasingly important in areas with inadequate infrastructure. Contaminated water sources can carry diseases, pathogens, and unacceptable levels of suspended solids or toxins. Consumption of contaminated water can lead to chronic illnesses and fatal disease—all detrimental to operational activities. However, potable water is only half the battle. Providing the critical infrastructure to deliver potable water can often require significant capital investments and can be time consuming. In many situations, neither the time nor the money exists to implement such complicated systems to provide access to good quality water.

### SUMMARY

The following presents a simplified summary in order to provide an understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for treating water and more particularly for producing high quality water in harsh environments on trailers.

Embodiments provide self-contained water treatment systems that provide potable water supply for crews and their living quarters in the field as well as for other users at other locations. These turnkey systems take feed water from wells, tanks, ponds, seawater, and other sources near potential worksites and purify it to drinking water quality. These systems accept source water up to 35,000 mg/L total dissolved solids (TDS) and deliver treated water at less than 500 mg/L TDS. Moreover, systems of embodiments are available from Omni Water Solutions Inc. of Austin Tex. under the name RHINO™. Systems of the current embodiment eliminate the cost of hauling potable water to work sites, refugee camps, disaster scenes, and other remote site while providing a dependable source of fresh water 24 hours per day/7 days per week. These systems are built for reliable operation in rugged conditions. Trained Omni experts continuously remotely monitor each system in the field to ensure performance to specifications and output of safe drinking water. Moreover, systems of the current embodiment include sensors, effectors, controllers etc. that allow the systems to run autonomously while being monitored remotely to ensure their performance and the delivery of water with user selected quality.

Systems of the current embodiment feature:
3,500 gallons/day drinking water output from contaminated sources
Reverse Osmosis filtration with sodium hypochlorite disinfection
Mixed Media and absorptive filtration
Purification to less than 500 mg/L total dissolved solids
Constant pressure distribution system
Stainless steel and composite construction
Built-in over pressure protection
Easy component access and serviceability
Built tough for harsh field conditions
2″ ball hitch, pull with ½ ton pickup

Embodiments provide water purification systems comprising trailers and feed water inlet ports, reverse osmosis units and/or multi-media filters, and one or more vibration dampers mounted on the trailers. Some of the vibration dampers can be operationally coupled to the trailer and the reverse osmosis units and/or multi-media filters. The vibration dampers of the current embodiment are configured to isolate the reverse osmosis units and/or multi-media filters from vibrations associated with movements of the trailer.

Furthermore, some water purification systems further comprise reverse osmosis unit pumps and motor and belt drives operationally coupled to the reverse osmosis units. Water purification systems of some embodiments further comprising enclosures and heaters and/or ventilation fans wherein the enclosures enclose the reverse osmosis units and/or multi-media filters, the heaters can heat the same, and the ventilation fans can ventilate the enclosures.

Water purification systems of various embodiments further comprise telecommunication interfaces, controllers, and water quality sensors which are in communication therewith. The controllers of the current embodiment transmit sensed conditions over the telecommunications interface. Moreover, water purification systems of embodiments further comprise effectors wherein the controllers are further configured to actuate the effectors responsive to the sensed conditions. If desired, some water purification systems further comprise recirculation lines from the reverse osmosis units and/or multi-media filters and, responsive to the sensed conditions, the controller can direct water from the reverse osmosis units and/or multi-media filters to the recirculation lines using the effectors. In addition, or in the alternative, the effectors can further comprise bodies formed from composite materials.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and/or nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 is a photograph of a water purification system.

FIG. 2 illustrates a piping and instrumentation diagram of a water purification system.

FIG. 3. illustrates a side elevation view of a water purification system.

FIG. 4. illustrates another side elevation view of a water purification system.

FIG. 5. illustrates yet another side elevation view of a water purification system.

FIG. 6. illustrates still another side elevation view of a water purification system.

FIG. 7. illustrates another side elevation view of a water purification system.

FIG. 8 illustrates a controller for a water purification system.

FIG. 9 illustrates various vibration/shock controls of water treatment systems.

FIG. 10 illustrates a partial system layout of a water distribution system.

### DETAILED DESCRIPTION

This document discloses systems, apparatus, methods, etc. for treating water and more particularly for treating water and more particularly for producing high quality water in harsh environments on mobile vehicles such as trailers.

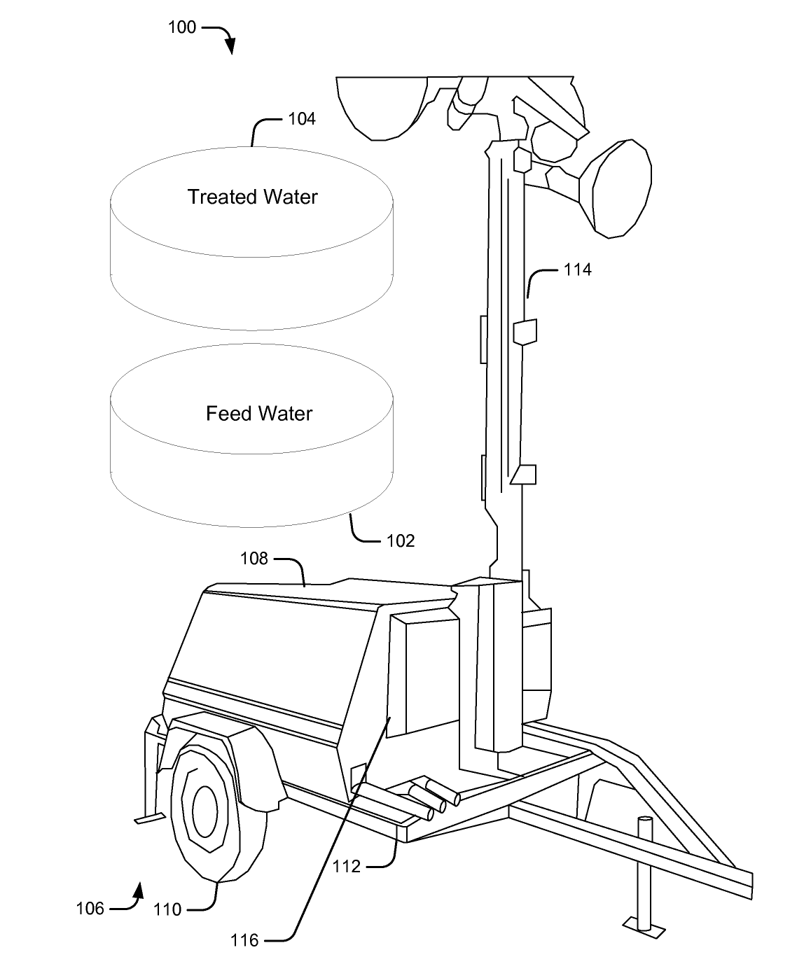

FIG. 1 illustrates a water purification system. Generally, FIG. 1 illustrates a water purification system mounted on a trailer and adapted for conditions likely to be present on and/or in the vicinity of the trailer. These adaptations include, but are not limited to, shock control, vibration control, thermal control, dust control, etc. Also, the system of the current embodiment comprises features enabling its autonomous operation for extended periods of time in those environments, without operation intervention, and with little (or nothing) in the way of consumables and/or hazardous chemicals. More specifically, FIG. 1 illustrates a system 100, a trailer 106, an enclosure 108, wheels 110, a frame 112, a light boom 114, a controller 116, water ports 118, and valves 120.

Typically, the system is used in conjunction with a feed water tank and a treated water tank (not shown in FIG. 1). The system 100 of the current embodiment draws water from the feed water tank (or other source) that might include significant concentrations of dissolved solids. The users of the system 100, moreover, often desire for those solids to be removed from the feed water by the system 100. It, therefore, treats the water and discharges it to the treated water tank (and/or other storage facility and/or a distribution system) for subsequent use.

Further still, being mounted on the trailer 106 allows the system 100 to be transported to potentially remote sites. Transporting the system 100, however, in this manner, might expose the fluid treatment components of the system 100 to environmental factors not ordinarily experienced by water treatment components and/or systems. For instance, while the trailer is being pulled, pushed, or otherwise urged along, its wheels 110 will often encounter holes, bumps, and/or other irregularities in the surface over which it travels. These irregularities, by their nature, cause shocks and vibration to be transmitted from the wheels 110 to the frame 112 and thence to the water treatment system and/or its components.

Some water treatment components exhibit certain susceptibilities to shock and vibration. For instance, shocks/vibrations can disturb high pressure seals present in many reverse osmosis (RO) units thereby leading to leaks between the feed water side of the RO membranes and the treated water side thereof. Likewise, other seals in these RO units can leak if exposed to shock/vibration thereby allowing feed water to leak from the unit and, perhaps more importantly, allowing treated water to leak therefrom. Moreover, the shaft seals of the high pressure pumps feeding most RO units are susceptible to minor misalignments between the pumps and the motors driving them. Shock and vibration, of course, increase the likelihood of such misalignments and therefore leaks. Other pumps, of course, can suffer due to exposure to shock/vibration. For instance, the ceramic blades of some pumps can crack/shatter if subjected to sufficient shock/vibration.

Furthermore, certain structures within the RO units support the RO membranes against the pressure differential across these membranes. These supports include portions abutting (and therefore supporting) the membranes and portions spaced apart therefrom to create flow paths for the water therein. If particulate matter becomes lodged between the supports and the membranes, vibration of the RO units can cause the particles to abrade and ultimately penetrate the membrane thereby leading to decreases in the quality of the water supposedly treated thereby.

Likewise, multi-media filters can suffer if subjected to shock and/or vibration such as that generated by transporting the system 100 on a trails 106. For one thing, shock and vibration can cause the various media in these filters to settle and/or even partially fluidize. In the case of settling, the finer-sized media can infiltrate the larger sized media and lead to an increase in the differential pressure needed to urge the water being treated through the filter. In the case of fluidization, shock and/or vibration could cause the particulate media to float thereby releasing particulate matter that they had previously filtered from the feed water. While some of that previously filtered particulate will likely be re-captured, it is also likely that some of it will escape from these multi-media filter and flow downstream. Once released, this particulate matter can foul downstream equipment. And, in the case of RO membranes can become trapped between the supports and the membranes thereby potentially leading to membrane damage, rupture, etc.

With continuing reference to FIG. 1, temperature extremes can also adversely affect water treatment components and/or systems. Cold weather can, of course, leading to water freezing in these components thereby clogging them and potentially rupturing these components. Cold can also cause the RO membranes to become less elastic thereby stressing them perhaps to rupture. Heat, can accelerate biological growth in water purification systems and can cause thermal expansion (and contraction when cold conditions exist) related stress on these systems and/or components. The thermal stresses, of course, can lead to component failure especially if many thermal cycles occur. The increased biologic growth caused by high temperature swings can cause component fouling, increased scaling, decreased treated water quality (particularly with regard to microorganisms), etc.

Still with reference to FIG. 1, users often desire to have treated water in environments subject to salt spray and/or the presence of brine/brine water. Indeed, at many sites, the only locally available “water” contains high quantities of salt to such an extent that it is referred to as brine. This salt can become airborne, deposit on the water treatment components of system 100. The deposited salt, of course, can aggravate corrosion of the components/system. And, being mounted on the trailer 106 in the current embodiment, the system 100 might be subject to such environments for extended times and without skilled service personnel being locally available.

Furthermore, and with ongoing reference to FIG. 1, water treatment systems can be difficult to operate successfully. For instance, multi-media filters and reverse osmosis filters can foul thereby necessitating operator intervention to clean them and return them to service. And, simply closing a valve(s) to isolate the failing, degraded, etc. component can aggravate the problem by causing a particulate-releasing water hammer to travel through the system (or portions thereof). As a result, many users manually monitor their systems on a continuous basis. Additionally, system upsets in one portion of a treatment system can propagate downstream to other portions of the system which are incapable of treating the material that should have been treated by the upset-impacted system position. As a result, these materials can remain entrained in what should have been treated water thereby leading to decreases in the quality of the treated water.

In other words, heretofore available treatment systems, components, methods, etc. teach against mounting water treatment systems on trailers and/or other mobile vehicles. Indeed, the Inventor has found that heretofore available mobile water treatment systems fail frequently, require high amounts of (if not constant) maintenance, and frequently fail to meet their water quality requirements. Moreover, they are typically limited in the types of feed water which they can treat.

With reference still to FIG. 1, the Inventor has found that these issues tend to have a synergistic impact on heretofore available water treatment systems which has to-date not been appreciated. The system 100 of the current embodiment therefore includes various features which mitigate these issues individually and taken as a whole. For instance, while the weight of the light boom 114 can aggravate the vibration/shock issues disclosed elsewhere herein, its presence allows users to elevate the light boom 114 thereby lighting the environment of the trailer 106/system 100 and allowing system 100 maintenance to occur even in dark or otherwise low visibility conditions. It might not be helpful to discuss, water treatment systems of embodiments in more detail.

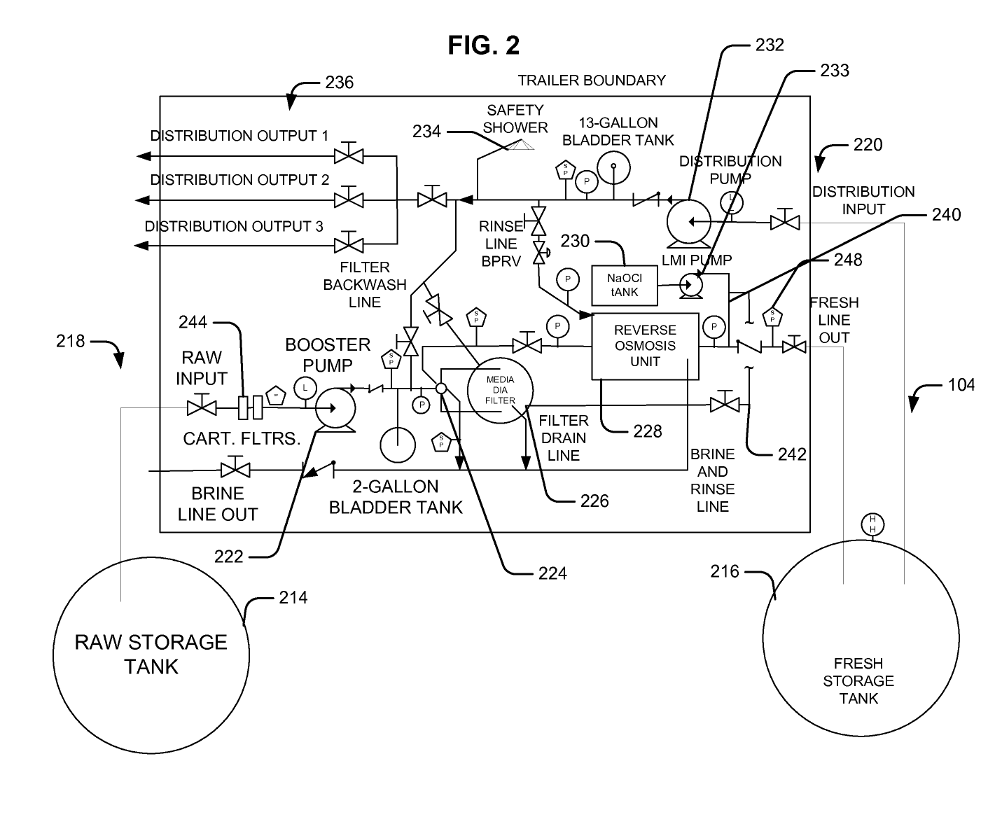

FIG. 2 illustrates a piping and instrumentation diagram of a water purification system. Generally, FIG. 2 shows a treatment train for purifying water. In accordance with the current embodiment, the system illustrated by FIG. 2 can treat feed water with TDS levels up to 35,000 mg/L and produce treated water with TDS less than or equal to about 500 mg/L. It does so with a multi-media filter and an RO unit through which the water being treated passes. Moreover, the system comprises features to mitigate issues associated with being mounted on trailers 106 and/or other mobile vehicles. More specifically, FIG. 2 illustrates a treatment train 218, a distribution subsystem 220, a booster pump 222, a four-way valve 224, a multi-media filter 226, an RO unit 228, a disinfectant source 230, a distribution pump 232, a safety shower 234, distribution valves 236, a brine recirculation line 238, a filter disinfectant line 240, an RO unit disinfectant line 242, and cartridge filters 244.

Typically, to mitigate vibration and/or shock, vibration dampers, shock absorbers, etc. are operationally coupled between the frame of the vehicle on which the system 210 is mounted and some or all of these components. For instance, because the booster pump 222 of embodiments has a ceramic impeller (although this feature is not required to practice the current disclosure) it is mounted on vibration absorbing pads. Also, both the multi-media filter 226 and RO unit 228 of the current embodiment rest (and/or are otherwise supported) on vibration absorbing pads. Of course, the trailer or other vehicle on which system 210 of the current embodiment is mounted comprises shock absorbers operationally coupled to its axle and/or frame to provide at least one layer of shock/vibration isolation for the components of system 210. Moreover, the booster pump 222, multi-media filter 226, and RO unit 228 (as well as other components) can have composite bodies, casings, etc. to mitigate corrosion caused by salt spray (and/or the like) in the environment surrounding the system 210. Note that the enclosure 108 (see FIG. 1) can be entirely or partially sealed to assist in mitigated the exposure of system 210 to (external) salt. As is further disclosed herein, that enclosure 108 can be actively/manually ventilated to mitigate heat build-up within the enclosure 108 whether due to internal sources or external sources (such as the sun). Space heaters, heat tracing, etc. can be included in enclosure 108 to mitigate the effects of cold weather on the system 210.

As is disclosed further herein, controller 116 can be configured to mitigate certain operational issues related to the functioning of system 210, its startup, its shutdown, upsets that might occur therein, etc. Again, as alluded to elsewhere herein, the Inventor has found that these features of the current embodiment work together synergistically to increase the reliability, operability, throughput, treated-water-quality, etc. of system 210.

With continued reference to FIG. 2, it might now be helpful to consider the system of the current embodiment in terms of its water treatment features. Thus considering various components more or less in the order in which water might encounter them, the system draws feed water from any convenient water source such as the feed water tank 214. Of course, that source could be a pond, a stream, a river, a salt marsh, a brine pond, the ocean, water produced as a result of industrial/commercial operations such as produced water from a hydrocarbon (or other type of) well, flow back water from fracking operations, etc. In the current embodiment, the feed water flows through one or more cartridge filters 244 such that gross particulates therein are removed. Booster pump 222 provides the motive force for drawing the feed water into the system 210. Note that the booster pump 222 of the current embodiment comprises an outer body of composite material for resistance to salt-induced (and/or other types of) corrosion. It also comprises ceramic impeller blades. While the ceramic impeller blades can tolerate fluids with high particulate concentrations they can present issues associated with shock/vibration. Accordingly, booster pumps 222 of embodiments can be mounted on vibration absorbing pads and/or otherwise protected against such environmental factors.

As to the four-way valve 224, it serves to direct water into/out of the multi-media filter 226. For instance, in one position, it directs partially filtered feed water into the multi-media filter 226 and directs the water flowing therefrom to the RO unit 228. In another position, it allows treated water from the distribution subsystem 220 to backwash and hence clean, refresh, rejuvenate, etc. the mixed media in the multi-media filter 226. In yet another position, it can direct water flowing from the multi-media filter 226 to the brine recirculation line should the controller sense that that water does not meet criteria for treatment by the RO unit 228. The multi-media filter 226 too can comprise a composite body to provide protection against corrosive materials in the environment external to the system 210.

With continuing reference to FIG. 2, the mixed-media filter 226 of the current embodiment provides for filtration of a variety of particulate matter of sizes down to <10 micron in diameter. Thus, (filtered) feed water can flow from it to the RO unit 228. It too can have a body made from composite material for resistance to external corrosive agents. In addition, or in the alternative, it can be mounted on vibration absorbing pads and/or otherwise isolated from shock/vibration.

With ongoing reference to FIG. 2, the RO unit 228 of the current embodiment comprises a bank of RO membranes through which the filtered feed water is passed to produce treated water. A byproduct of this process is brine which is feed back to the source of the feed water (via brine recirculation line 238 or otherwise disposed of. In some embodiments, the RO unit 238 comprises a composite body to protect it from external corrosive materials and/or is isolated from shock vibrations by vibration absorbing pads and/or otherwise.

From the RO unit 228, the (partially treated) water flows towards the treated water tank 216 of the current embodiment. However, the controller meters disinfectant from the disinfectant source 230 using the disinfectant pump 233 and appropriate valves, instruments etc. In some embodiments, the disinfectant used is sodium hypochlorite although other disinfectants can be used. Thus, the water flowing from the RO unit 228 is typically suitable for drinking as well as other uses. Moreover, it can be stored in an external facility such as treated water tank 216. Note that the source of the feed water (for instance, feed water tank 214) can also be external to the trailer/system. Of course, if desired, the treated water could be fed directly to points of use and/or some distribution system.

Moreover, systems 210 of the current embodiment do include a distribution subsystem 220 which is mounted on the trailer or other mobile vehicle. That distribution subsystem 220 includes the distribution pump which can be a high capacity/high pressure pump since it (in the current embodiment) draws treated water from storage in the treated water tank 216 (rather than relying on the flow/pressure coming directly from the RO unit 228. The distribution pump 232 can include ceramic and/or stainless steel impellers and/or can comprise a composite body for resistance caused by external agents.

From the distribution pump 232, the treated water can flow to a variety of points of use as directed by the distribution valves 236 and/or other fluid handling components. For instance, since the distribution pump 232 can deliver a high flow rate of treated water a safety shower 234 could be included in and/or connected to the system 210. Thus, the distribution subsystem 220 is independent of the treatment train 218 at least for some period of time.

It might also be worth noting that the disinfectant source 230 and/or disinfectant pump are in communication with both the multi-media filter 226 and RO unit 228. In this way, when the controller determines that a cleaning cycling might be called for, disinfectant can be directed to these components to aid in cleaning them, clearing fouling materials, reactivating absorptive media beds, sanitizing biological materials which might have found their way into the system and/or grown there. Furthermore, the system 210 of the current embodiment includes lines for recirculating treated water from the distribution subsystem 220 and from the discharge of the multi-media filter 226 to earlier components in the treatment train 218 to allow for cleaning, back flushing, etc.

However, these recirculation lines serve at least one other purpose: namely providing a means for the controller to startup the system and/or to recover from upsets and/or the like. More specifically, the controller monitors water quality via a set of sensors 246 and/or 248. The sensors 246 and 248 monitor, respectively, water quality as the water exits the multi-media filter 226 and the RO unit 228 (albeit after the disinfectant injection line). If the water at either location is not suitable for the next stage of the system 210, the controller repositions appropriate valves and/or other effectors to recirculate the affected water back to the feed water source. Moreover, the controller then recirculates water through the stage (the multi-media filter 226 or RO unit 228) most capable of restoring the water to the desired quality. Once the water (exiting that stage) meets the appropriate criteria, the controller repositions the valves and allows the system to resume is desired operation. In addition, or in the alternative, if the sensed water quality indicates that cleaning of the system (or some of its components) might be desirable, the controller can direct back flow water/disinfectant to the appropriate components. Note that in some embodiments the controller uses set points of, respectively, approximately 500 uS and approximately 0.02 Cl2 as sensed by sensors 246 and 248

In addition, or in the alternative, systems of some embodiments include space heaters, heat tracing, etc. to protect the system from low temperatures. Some systems, furthermore, can include ventilation fans, vents, etc. to protect the system 210 and/or its components from high temperatures. Note that these high temperature protection means can be helpful with respect to systems 210 largely located in sealed enclosures. See FIG. 1. Thus, even when the system 210 is in a (partially) sealed enclosure, the system operates in a synergistic fashion to operate notwithstanding high TDS feed water, low environmental temperatures, high environmental temperatures (heat loads), corrosive (external) environments, shock, vibration, etc.

In this manner, the system 210 of the current embodiment can operate autonomously for extended periods of time. Moreover, it can do so in the absence of operator intervention. And, it can do so despite thermal, shock, vibration, etc. outside of that typically encountered by water treatment systems and/or their components.

Note that, for the sake of clarity, not all components of system 210 are illustrated by FIG. 2. It will be understood by those skilled in the art that other components such as pressure controls (for instance, bladder tanks), instrumentation, manual valves, automatic valves, etc. can be included in the system 210 without departing from the scope of the current disclosure.

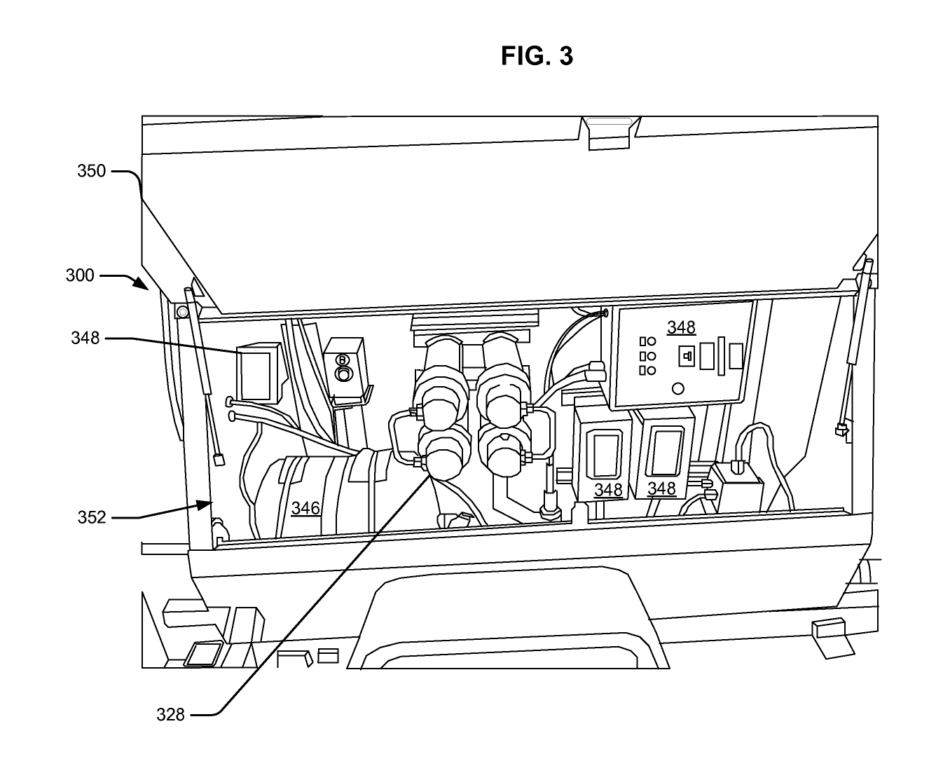

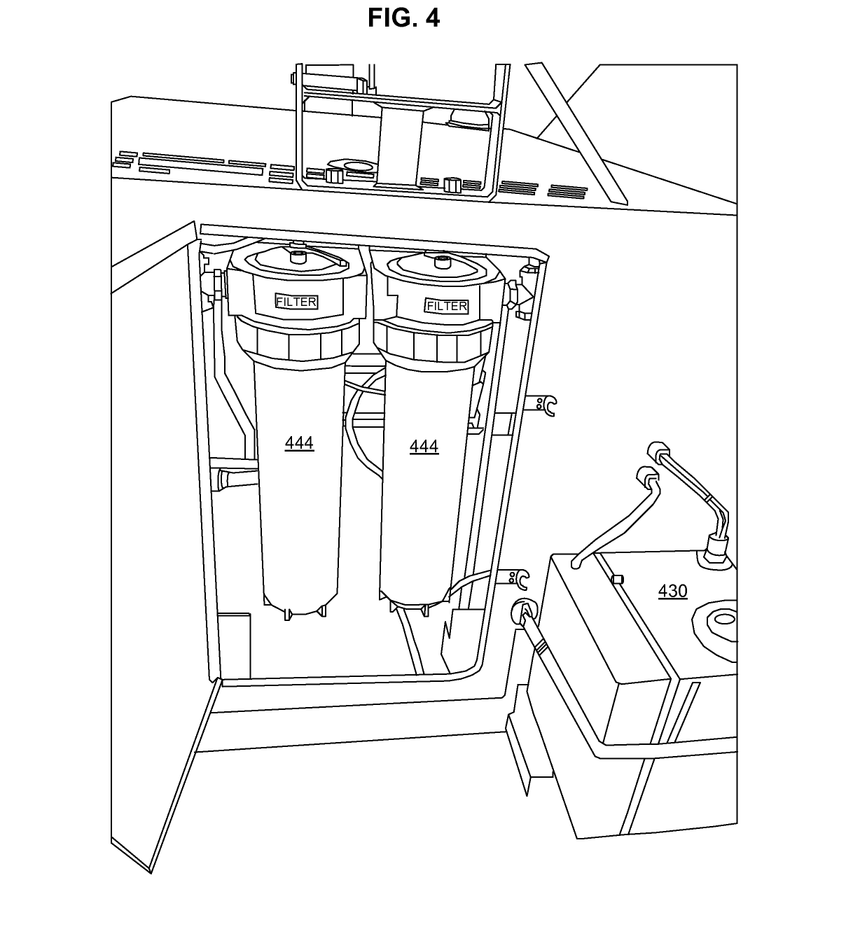

FIG. 3. illustrates a side elevation view of a water purification system. Generally FIG. 3 (and FIGS. 4-7) illustrate that all components which might require service are within 2½ feet of a hatchway. Thus, even though systems 300 of embodiments do not ordinarily require a skilled water treatment technician to be present for its operation, these serviceable components can be readily accessed should the desire to do s arise. More specifically, FIG. 3 illustrates a bladder tank (for controlling pressure surges which might originate from one of the pumps) and a bank of four (4) RO tubes 328 (of an RO unit) within the enclosure of the trailer. They have been oriented horizontally to facilitate removal and replacement of the RO membranes housed therein. In addition, FIG. 3 illustrates that a number of electrical enclosures 348b can be placed within the protective enclosure of the trailer. These electrical enclosures can house the electronic controls, instruments, signal conditioners, electrical actuators, etc. used in conjunction with the system 300. Moreover these figures also illustrate that all components which might be sensitive to the external environment are protected by an enclosure from thermal excursions, vibration, shock, etc.

With continuing reference to FIG. 3, the drawing also shows a hatch 350 and corresponding hatchway 352. This hatch 350 and other hatches on the trailer can be sealed around their edges and (as with the remainder of the trailer enclosure) can include thermal insulation, dust seals, salt spray/water/air infiltration seals, etc. When closed, the hatches 350 therefore assist in protecting the components in the enclosure. When open, these hatches allow access to the serviceable components therein.

FIG. 4. illustrates another side elevation view of a water purification system. More specifically, FIG. 4 illustrates a disinfectant tank 430 and a pair of filter cartridges 444. Again, the filter cartridges are installed inside of the protective enclosure of the trailer and can be accessed via a protective hatch 450/hatchway 452. In the case of the disinfectant tank 430, it is mounted outside the protective enclosure to save internal volume and since it and the disinfectant (sodium hypochlorite in the current embodiment) can tolerate at least the thermal environment reasonably expected in the vicinity of the trailer.

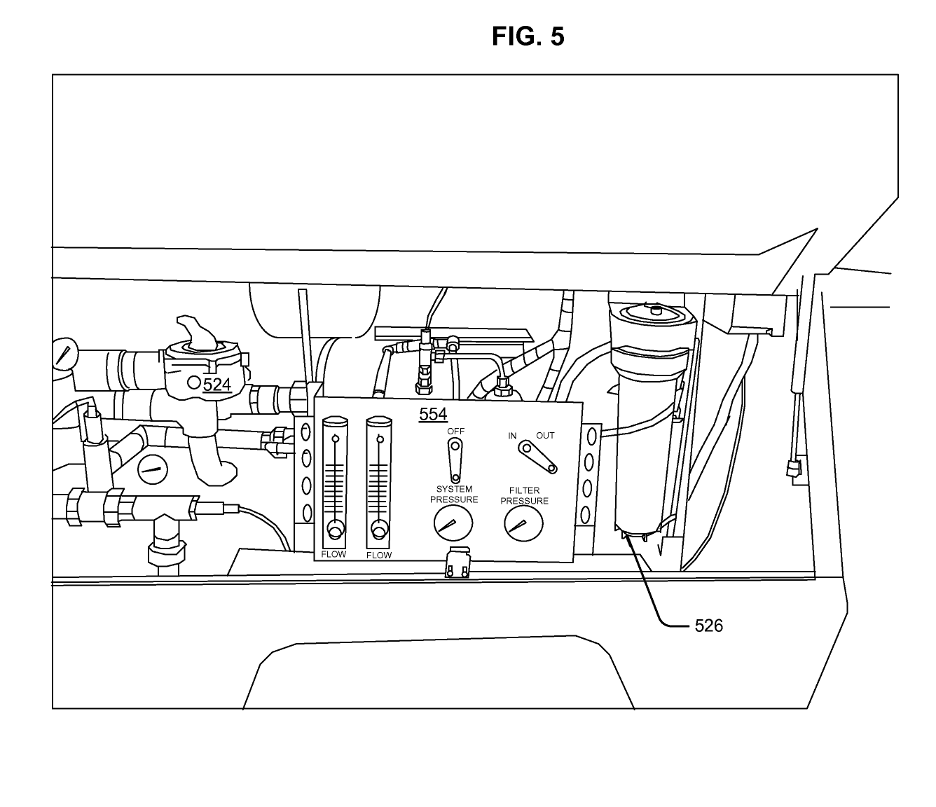

FIG. 5. illustrates yet another side elevation view of a water purification system. More specifically, FIG. 5 illustrates four way valve 524, multi-media filter 526, and mechanical control panel 554. These components are installed in the protective enclosure of the trailer and are accessible via a hatch also. The mechanical control panel 554 includes a number of mechanical instruments, manual valves, etc. for use by users who might wish to manipulate the water treatment system of which they are a part.

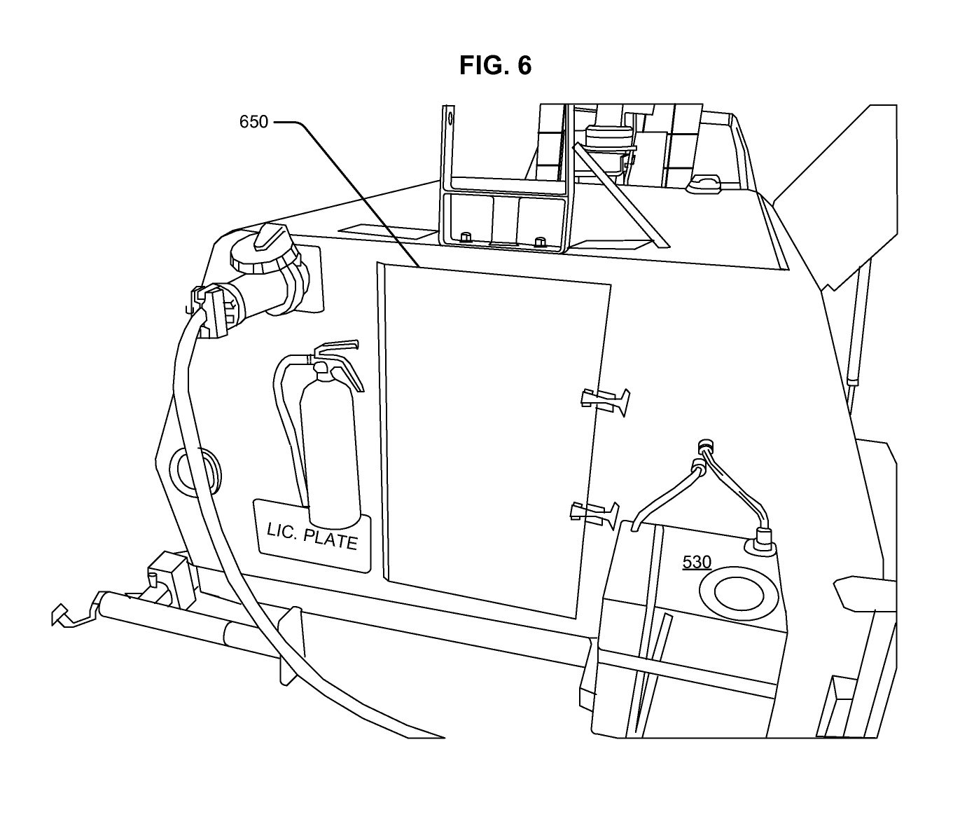

FIG. 6. illustrates still another side elevation view of a water purification system. More specifically, FIG. 6 shows the hatch 650 in its closed, latched, and seal position. It also illustrates an electrical power connector 656 which can be used to power the various pumps, heaters, valves, controllers, etc. on the trailer.

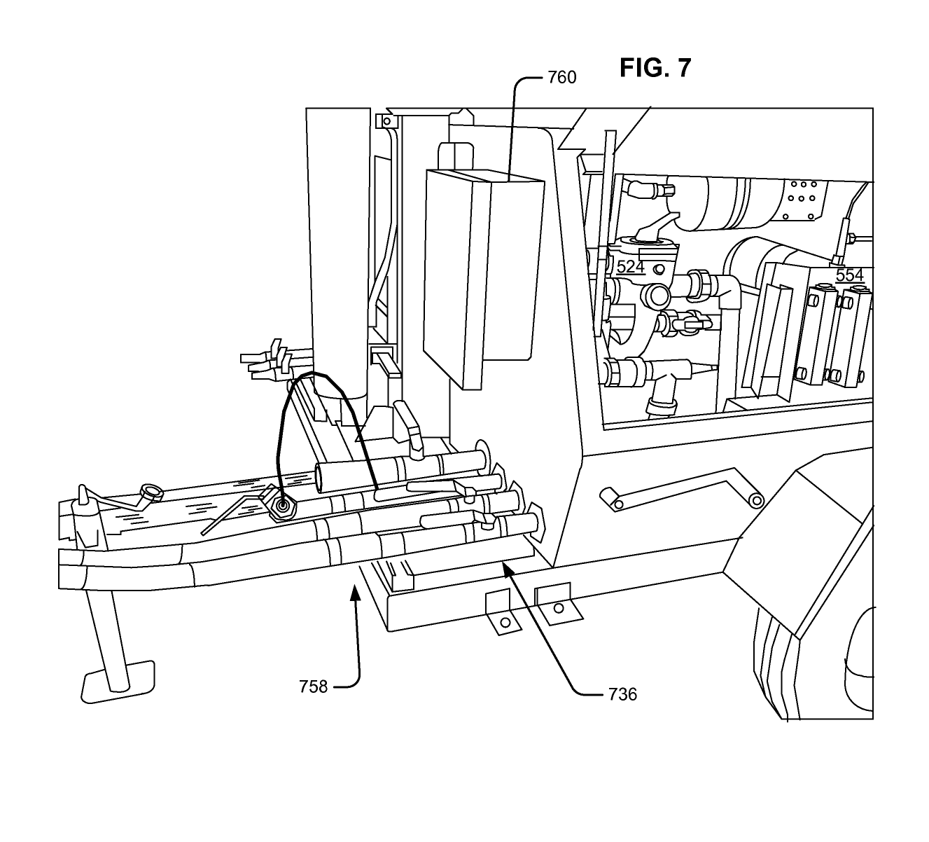

FIG. 7. illustrates another side elevation view of a water purification system. This drawing shows a series of inlet/outlet valves 736 and inlet/outlet ports 758. These components are grouped together for the convenience of users who might wish to place the system in service, operate it, remove it from service, etc. And, as with the mechanical control panel 554 pipes, tubes, hoses, etc. can be routed to from these components to connect them as shown in FIG. 2.

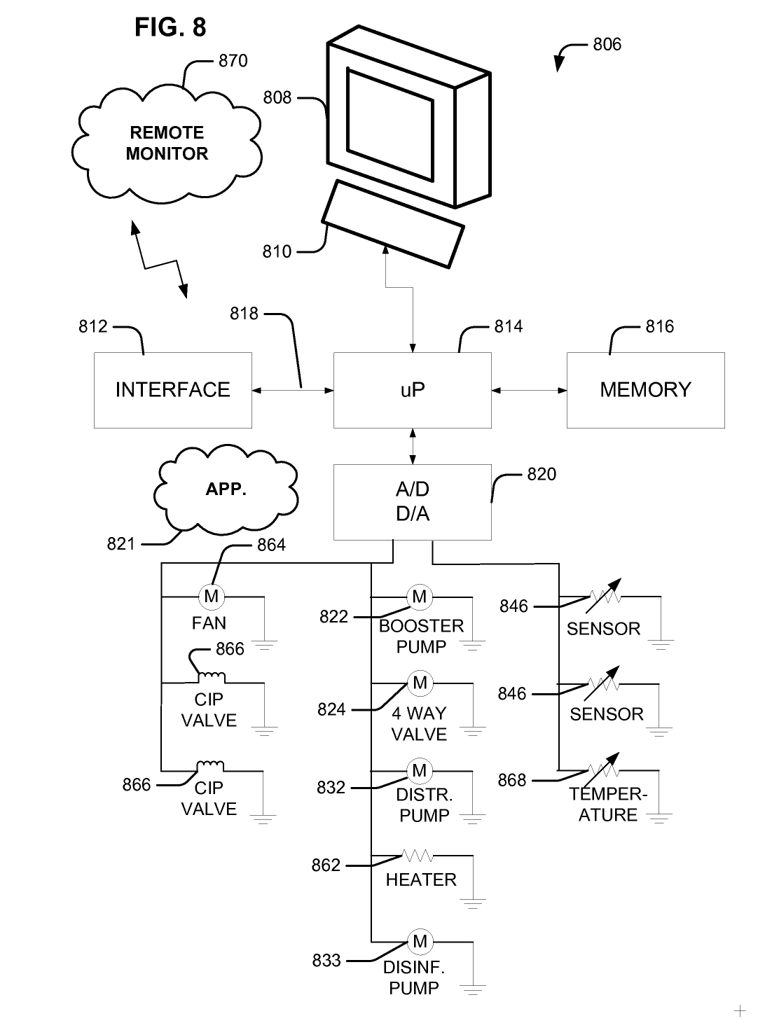

FIG. 8 illustrates a controller for a water purification system. Generally, FIG. 8 illustrates a computer-based controller that senses conditions in/affecting water treatment systems of embodiments. More specifically, FIG. 8 illustrates that the controller 800 includes a computer further comprising display 808, keyboard 810, interface 812, processor 814, memory 816, a bus 818, an analog to digital/digital to analog converter 820 and an application 821 (hosted/resident in the computer 806). FIG. 8 also schematically illustrates a booster pump 822, a four way valve 824, a distribution pump 832, a heater 862, sensors 846 and 848, a fan 864, clean in place (CIP) valves 866, and a temperature sensor 868. The converter 820 allows the computer to communicate with/control the various sensors and effectors illustrated by FIG. 8. For instance, the controller 800/application 821 can sense the water conditions in the system via sensors 846 and 848. It can then turn on/off the pumps 822, 832, and/or 833 and/or reposition the valves 824 and/or 866 as disclosed elsewhere herein to operate water treatment systems of embodiments.

Note that the controller 800 can also sense the temperature(s) in the protective environments inside the enclosures associated with these systems using temperature sensors 868 and turn on/off the heaters 862. It can also, responsive thereto, turn on/off the ventilation fan 864. Note also that the controller can vary the wattage used by the heater 833 if proportional control of the internal temperature is desired. Likewise, the controller 800 can vary the speeds of the various pumps, valves, etc. if proportional control of these components is desired.

In addition/or in the alternative, the controller 800 can host application(s), programs, algorithm(s), routine(s), etc. to perform the operations disclosed further herein. More specifically, the controller 800 can gather and store the sensed conditions, positions of the valves, speed of the pump motors, etc. and store them in the memory 816. It can also transmit such information over interface 812 to a remote monitoring facility 870. The transmitted information can thus be monitored by users and/or other applications resident at that facility. Thus, skilled technicians can monitor water treatment systems of embodiments without following the trailers (housing them) around and/or without leaving the remote monitoring facility 870. These activities of course can be facilitated by the Internet, a WAN, a LAN, a telecommunications system (for instance a cellular telephony network), etc. Thus, users at the potentially remote, hazardous, harsh, etc. sites where these systems happened to be positioned can realize a cost savings by not needing to have these skilled technicians or other users on site to operate/monitor water treatment systems of embodiments.

Still with reference to FIG. 8, a few words might be in order about the control system 800 used to monitor and control systems of embodiments. The type of computer 806 used for such purposes does not limit the scope of the disclosure but certainly includes those now known as well as those which will arise in the future. But usually, these computers 806 will include some type of display 808, keyboard 810, interface 812, processor 814, memory 816, and bus 818.

Indeed, any type of human-machine interface (as illustrated by display 808 and keyboard 810) will do so long as it allows some or all of the human interactions with the computer 806 as disclosed elsewhere herein. Similarly, the interface 812 can be a network interface card (NIC), a WiFi transceiver, an Ethernet interface, etc. allowing various components of computer 806 to communicate with each other and/or other devices. The computer 806, though, could be a stand-alone device without departing from the scope of the current disclosure.

Moreover, while FIG. 8 illustrates that the computer 806 includes a processor 814, the computer 806 might include some other type of device for performing methods disclosed herein. For instance, the computer 806 could include a microprocessor, an ASIC (Application Specific Integrated Circuit), a RISC (Reduced Instruction Set IC), a neural network, etc. instead of, or in addition, to the processor 814. Thus, the device used to perform the methods disclosed herein is not limiting.

Again with reference to FIG. 8, the memory 816 can be any type of memory currently available or that might arise in the future. For instance, the memory 816 could be a hard drive, a ROM (Read Only Memory), a RAM (Random Access Memory), flash memory, a CD (Compact Disc), etc. or a combination thereof. No matter its form, in the current embodiment, the memory 816 stores instructions which enable the processor 814 (or other device) to perform at least some of the methods disclosed herein as well as (perhaps) others. The memory 816 of the current embodiment also stores data pertaining to such methods, user inputs thereto, outputs thereof, etc. At least some of the various components of the computer 806 can communicate over any type of bus 818 enabling their operations in some or all of the methods disclosed herein. Such buses include, without limitation, SCSI (Small Computer System Interface), ISA (Industry Standard Architecture), EISA (Extended Industry Standard Architecture), etc., buses or a combination thereof. With that having been said, it might be useful to now consider some aspects of the disclosed subject matter.

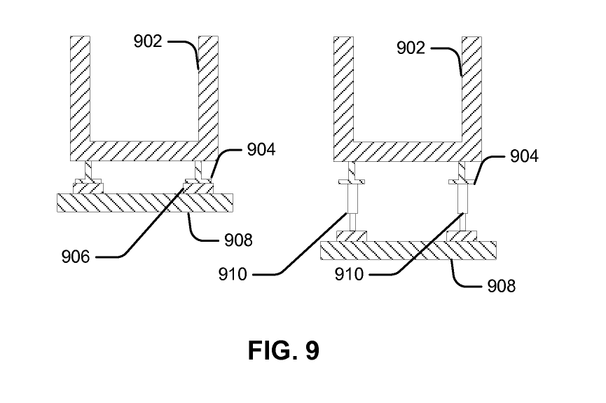

FIG. 9 illustrates various vibration/shock controls of water treatment systems. More specifically, FIG. 9 illustrates a pair of water treatment system components 900, their mounted feet 904, vibration absorbing pads 906, a frame 908 of a trailer, and shock absorbers 910. As disclosed elsewhere herein, some water treatment system components 900 can be susceptible to vibration/shock and these conditions can combine with other environmental factors synergistically thereby rendering operation of some water treatment systems somewhat difficult to operate. The vibration damping pads 906 and/or shock absorbers 910 are selectively coupled between some water treatment system components 900 and the frame 908 of the trailer. They therefore can absorb/control vibrations/shocks emanating from the trailer frame 908 and/or surface over which the trailer might travel thereby mitigating the effects of these vibrations/shocks on the water treatment system components 900. Of course, the trailer and/or trailer frame 908 can be configured to include such vibration/shock mitigation features too.

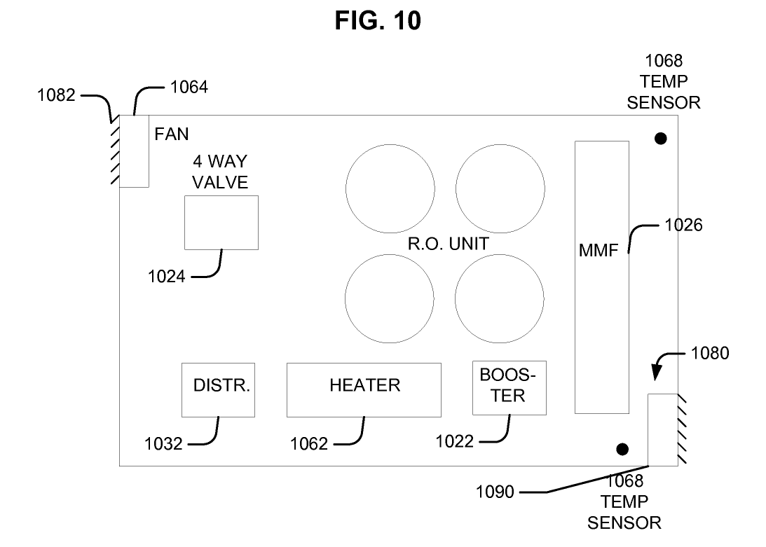

FIG. 10 illustrates a partial system layout of a water distribution system. More specifically, the drawing shows a system 1000, a booster pump 1022, a four-way valve 1024, multi-media filter 1026, an RO unit 1028, a distribution pump 1032, a heater 1062, a fan 1064, temperature sensors 1068, a louver 1080, and another louver 1082. Note that the components most likely to produce heat (the booster pump 1022 and distribution pump 1032) are located near the bottom of the enclosure along with the heater 1062. In this manner, as well as perhaps others, their heat load can contribute to warming the system 1000 during cold weather. Furthermore, one of the temperature sensors 1068 of the current embodiment is also positioned low so as to sense cold conditions. It is also placed near the incoming air louver 1080 to detect possible cold air infiltration. It is also positioned away from the heater 1062 to prevent it from causing short cycling of the heater 1062 by the controller.

The other temperature sensor 1068 is positioned near the top of the system 1000 and away from the fan 1064 of the current embodiment. In this way, and perhaps others, short cycling of the fan 1064 can be avoided. Note that the fan 10064 can be positioned near the top of the system 1000 so that it draws warm air from the enclosure. It is also positioned near the discharge louver 1082 to direct that warm air out of the enclosure. Note that louvers 1080 and 1082 can be passively or actively actuated. In the case of passive louvers, the force of the air being drawn to/blown from the fan 1064 can open these louvers 1080 and/or 1082. If active control is desired, the louvers 1080 and/or 1082 can be controlled by the controller. Of course, in their closed positions, the louvers 1080 and 1082 can seal the enclosure and a filter 1090 can be provided to filter air drawn into the enclosure.

Thus, embodiments provide mobile water treatment systems for use in potential remote, harsh, hazardous, etc. environments. Despite the potential presence of thermal excursions, dust, salt spray, salt dust, dust, thermal excursions, vibration, shock, etc. in the vicinity of water treatment systems of embodiments, they can produce high quality, potable/drinking water (or better) suitable for human beings. Moreover, they can do so at lower cost than heretofore possible.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A water purification system comprising:
a mobile vehicle;
a feed water inlet port;
a reverse osmosis unit in fluid communication with the feed water inlet port;
a treated water outlet port in fluid communication with the reverse osmosis unit wherein the feed water inlet port, the reverse osmosis unit and the treated water outlet port are mounted on the mobile vehicle; and
a first vibration control operationally coupled to the mobile vehicle and the reverse osmosis unit and being configured to at least partially isolate the reverse osmosis unit from vibrations which are associated with a movement of the mobile vehicle.

2. The water purification system of claim 1 further comprising a multi-media filter in fluid communication with the feed water inlet port and the reverse osmosis unit and being mounted on the mobile vehicle.

3. The water purification system of claim 1 further comprising a second vibration control operationally coupled to the mobile vehicle and to the multi-media filter and being configured to at least partially isolate the multi-media filter from vibrations associated with the movement of the mobile vehicle.

4. The water purification system of claim 1 further comprising a reverse osmosis unit pump in fluid communication with an inlet of the reverse osmosis unit, the water purification system further comprising a motor and a belt drive, the pump and the reverse osmosis unit pump being operationally coupled together by the belt drive.

5. The water purification system of claim 1 further comprising an enclosure and a heater, the enclosure enclosing the reverse osmosis unit and the heater being configured to heat the reverse osmosis unit.

6. The water purification system of claim 1 further comprising an enclosure and a ventilation fan being configured to ventilate the enclosure.

7. The water purification system of claim 1 further comprising a controller, a set of sensors in communication therewith, and a telecommunications interface, the controller being configured to sense a set of water conditions in the water purification system and to transmit a set of the sensed conditions over the telecommunications interface.

8. The water purification system of claim 7 further comprising a set of effectors in communication with the controller, the controller being further configured to actuate the effectors responsive to the set of sensed conditions.

9. The water purification system of claim 8 further comprising a fluid recirculation line in fluid communication with the reverse osmosis unit wherein the controller is further configured to sense a level of dissolved solids in water exiting the reverse osmosis unit via one of the sensors and to direct the water to through the recirculation line responsive to the sensed dissolved solids exceeding a user selected threshold using one of the effectors.

10. The water purification system of claim 1 wherein the water purification system includes a set of effectors which all of which further comprising bodies formed from composite materials.

11. A water purification system comprising:
a mobile vehicle;
a feed water inlet port;
a multi-media filter in fluid communication with the feed water inlet port;
a treated water outlet port in fluid communication with the multi-media filter wherein the feed water inlet port, the multi-media filter and the treated water outlet port are mounted on the mobile vehicle; and
a first vibration control operationally coupled to the mobile vehicle and the multi-media filter and being configured to at least partially isolate the multi-media filter from vibrations which are associated with a movement of the mobile vehicle.

12. The water purification system of claim 11 further comprising a reverse osmosis unit in fluid communication with the multi-media filter and the treated water outlet port and being mounted on the mobile vehicle.

13. The water purification system of claim 12 further comprising a second vibration control operationally coupled to the mobile vehicle and to the reverse osmosis unit and being configured to at least partially isolate the reverse osmosis unit from vibrations associated with the movement of the mobile vehicle.

14. The water purification system of claim 12 further comprising a reverse osmosis unit pump in fluid communication with an inlet of the reverse osmosis unit, the water purification system further comprising a motor and a belt drive, the pump and the reverse osmosis unit pump being operationally coupled together by the belt drive.

15. The water purification system of claim 11 further comprising an enclosure and a heater, the enclosure enclosing the multi-media filter and the heater being configured to heat the multi-media filter.

16. The water purification system of claim 11 further comprising an enclosure and a ventilation fan being configured to ventilate the enclosure.

17. The water purification system of claim 11 further comprising a controller, a set of sensors in communication therewith, and a telecommunications interface, the controller being configured to sense a set of water conditions in the water purification system and to transmit a set of the sensed conditions over the telecommunications interface.

18. The water purification system of claim 17 further comprising a set of effectors in communication with the controller, the controller being further configured to actuate the effectors responsive to the set of sensed conditions.

19. The water purification system of claim 18 further comprising a fluid recirculation line in fluid communication with the multi-media filter wherein the controller is further configured to sense a level of dissolved solids in water exiting the multi-media filter via one of the sensors and to direct the water to through the recirculation line responsive to the sensed dissolved solids exceeding a user selected threshold using one of the effectors.

20. A water purification system comprising:
a trailer;
a feed water inlet port;
a multi-media filter in fluid communication with the feed water inlet port;
a treated water outlet port in fluid communication with the multi-media filter wherein the feed water inlet port, the multi-media filter and the treated water outlet port are mounted on the trailer;
a reverse osmosis unit in fluid communication with the multi-media filter and the treated water outlet port and being mounted on the trailer;
a first vibration damper operationally coupled to the trailer and the multi-media filter and being configured to at least partially isolate the multi-media filter from vibrations which are associated with a movement of the trailer;
a second vibration damper operationally coupled to the trailer and to the reverse osmosis unit and being configured to at least partially isolate the reverse osmosis unit from vibrations associated with the movement of the trailer; and
a reverse osmosis unit pump in fluid communication with an inlet of the reverse osmosis unit, the water purification system further comprising a motor and a belt drive, the pump and the reverse osmosis unit pump being operationally coupled together by the belt drive;
a first fluid recirculation line in fluid communication with the multi-media filter; and
a second fluid recirculation line in fluid communication with the reverse osmosis unit.
